(19) United States
(12) Patent Application Publication
(10) Pub. No.: US 2004/0141275 A1
(43) Pub. Date: Jul. 22, 2004

(54) Active EMI filter for power switching circuit output

(75) Inventor: Frank Athari, Oceanside, CA (US)

Correspondence Address: OSTROLENK FABER GERB & SOFFEN, 1180 AVENUE OF THE AMERICAS, NEW YORK, NY, 100368403

(73) Assignee: International Rectifier, Inc.

(21) Appl. No.: 10/650,246

(22) Filed: Aug. 28, 2003

Related U.S. Application Data
(60) Provisional application No. 60/407,573, filed on Aug. 29, 2002.

(51) Int. Cl. H02H 9/06

(52) U.S. Cl. 361/118

(57) ABSTRACT

A circuit arrangement comprising a power transistor switching stage providing an output voltage and an active EMI filter having an input and an output, the input of the active EMI filter connected to receive the output voltage and the output of the active EMI filter providing a filtered output voltage.

### CROSS REFERENCE TO RELATED APPLICATION

This application claims the benefit and priority of provisional application S.No. 60/407,573 filed Aug. 29, 2002 entitled “ACTIVE AMI FILTER FOR POWER SUPPLY OUTPUT”, the entire disclosure of which is incorporated by reference herein.

### BACKGROUND OF THE INVENTION

The present invention relates to power switching circuits such as power supplies and converters, and in particular, switching mode power supplies, and even more particularly, to active EMI filters for such power supplies and converters.

Switching mode power supplies (SMPS) have been available for some time and provide significant advantages including high efficiency, low cost, and light weight. They are particularly well adapted to modern electronic devices such as personal computers, and in particular, laptops. They are used, for example, to provide the power supplies for laptop computers, converting the battery DC voltage into a lower voltage DC power supply voltage for the laptop computer of only about a few volts DC, e.g., 1-3 volts, and capable of handling high currents. A problem with switching mode power supplies is that because of the high frequency of the switching action of the semiconductor switches, electromagnetic interference (EMI) is generated and in particular EMI is conduced back to the power source or radiated.

It is also known to provide EMI filters to eliminate such high frequency radiated and conducted noise. Typically, passive filters are employed. In addition, active EMI filters have been developed, some of which operate from a feedback mode and others of which operate in the feed forward design. The reader is referred to Ser. No. 10/146,334 (IR-1744 (2-2597)) which describes an active EMI filter including an amplifier stage which cancels out the common mode current that flows to the load from a converter output. The disclosure of this application is incorporated herein by reference.

As far as applicant is aware, the known active EMI filters are all employed at the input to the converter or switching mode power supply. Typically, current sensing is performed either in the DC bus or on the AC main or in the return ground line and the amplifier which is coupled to the ground line through an isolating capacitor, is coupled into the DC bus and therefore at the input to the power switching stage. Applicant is not aware of any circuits employing switching mode power supplies which utilize an active EMI filter at the output of the switching mode power supplies.

It is desirable to eliminate the EMI created by a switching mode power supply or other power transistor switching stage at the output, instead of at the input because the physical size of the EMI filter can be reduced and typically, in the case of a buck converter, the voltage levels at which the EMI filter operates will be lower than at the input, allowing use of lower rated components.

### SUMMARY OF THE INVENTION

It is an object of the present invention to provide an active EMI filter for a power transistor switching circuit, for example, a converter or switching mode power supply and which active EMI filter is disposed at the output of the switching stage.

The device of the present invention has advantages in that it reduces the physical size of the output EMI filtering for power supplies, it minimizes power losses associated with passive EMI filters, it is inherently adapted to a wide range of electromagnetic noise frequencies, eliminating the need for complex design and optimization typical of passive filtering techniques, and it reduces voltage ratings of components.

The active EMI filter of the present invention can be placed on the output lines of an off line or a dc-dc power supply having either a DC or AC (Inverter) output to reduce output electromagnetic noise emissions without the power losses and large physical size of traditional passive filters.

### BRIEF DESCRIPTION OF THE DRAWING(S)

The present invention will now be described in greater detail in the following detailed description, with reference to the drawings in which:

FIG. 1 is a block diagram showing the active EMI filter according to the present invention at the output stage of a switching mode power supply; and

FIG. 2 shows an example of an active EMI filter for use according to the invention.

### DETAILED DESCRIPTION OF PREFERRED EMBODIMENTS

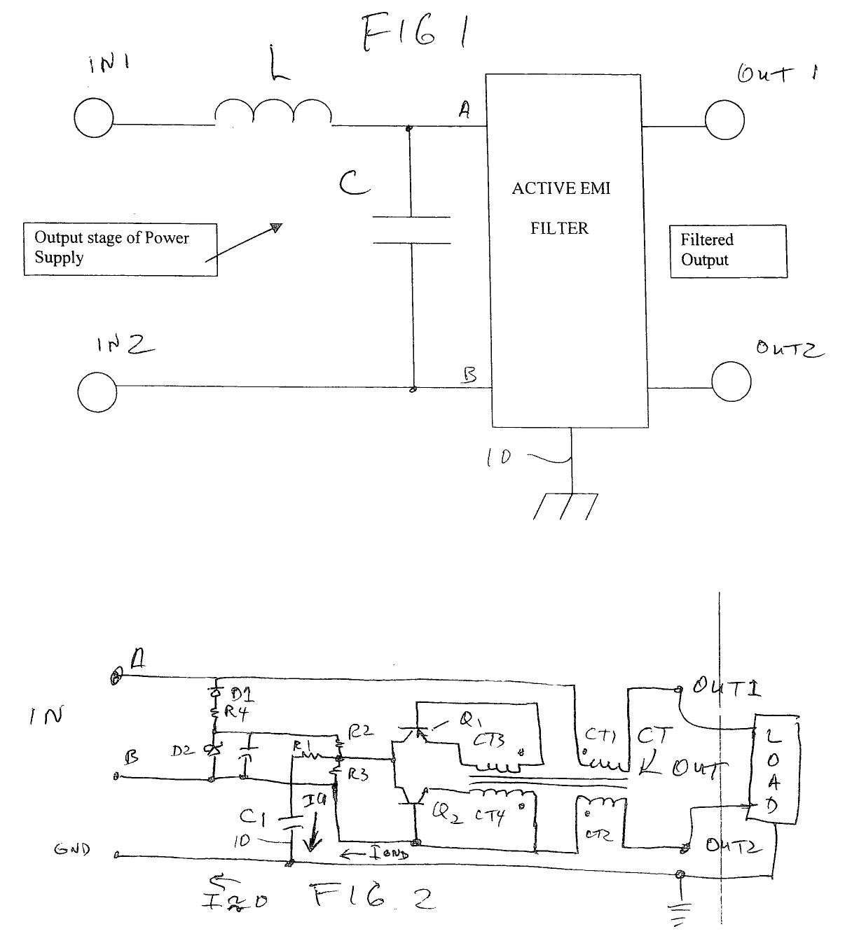

With reference now to the drawings, FIG. 1 shows the output stage of a switching mode power supply in particular, a typical buck converter. In FIG. 1, only the output stage of the buck converter is shown. The output stage includes an inductor L and a capacitor C. Typically, as well known, two switches are employed in the buck converter, one of which is connected across the input terminals IN1 and IN2 and the other of which is connected to one of the input terminals and to an input voltage source. The two switches are controlled according to a control scheme such that they are alternately turned on and off according to a pulse width modulation technique to control the DC voltage across the capacitor C. The switch across the input terminals IN1 and IN2 may comprise a simple diode polarized such that its anode is connected to the terminal IN2. Although a buck converter is shown and described, the power switching circuit could be any other type of SMPS or could be a converter, such as an inverter, e.g., an inverter driving an AC motor.

According to the invention, the input A-B of the active EMI filter is coupled across the capacitor C and its output is connected to OUT1 and OUT2. The active EMI filter has a further lead 10 connected to ground for serving to cancel noise currents causing EMI.

An example of an active EMI filter which can be used according to the present invention is shown in FIG. 2. The EMI filter has its input terminals A and B as shown connected across capacitor C. The active EMI filter includes an amplifier stage comprising two transistors Q1 and Q2. The transistors Q1 and Q2 have their collectors connected together through a resistor R1 and capacitor C1 coupled to the ground return line which couples the input and output grounds. The active EMI filter cancels the common mode current which flows between the input and output, that is, between terminals A and B and terminals OUT1 and OUT2. A current transformer CT is provided having two primaries CT1 and CT2. One primary CT1 is connected in the line A between A and OUT1 and the other primary CT2 is connected in the line connecting B and OUT2. The current transformer includes secondaries CT3 and CT4. When a common mode noise current flows in the load connected to OUT 1 and OUT2 between the load and the ground line, the common mode current, which flows in both lines A-OUT1 and B-OUT2, will flow in the two primaries CT1 and CT2. The differential mode current will be canceled. Likewise, a normal mode current will be canceled by the polarization of the transformer primaries CT1 and CT2. However, the common mode current will be reflected additively in the secondaries CT2 and CT4. Depending upon the direction of the current in the secondaries CT3 and CT4, only one of the transistors Q1 and Q2 will be conductive. Note that the transistors Q1 and Q2 are complementary. In the design shown, Q1 is a PNP transistor and Q2 is an NPN transistor. Depending on the flow of the common mode current, one of the two transistors Q1 and Q2 will be turned on allowing the current generated in he particular secondary to flow through the isolating capacitor C1 (current ICI) to cancel the ground noise current IGND flowing in the ground line, thereby canceling the ground noise current flowing back to the input. Thus, the electromagnetic interference reflected back to the input is canceled and the radiated emissions reduced.

Resistors R2, R3 and R4 and diodes D1 and D2 provide a power source for transistors Q1 and Q2.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A circuit arrangement comprising a power transistor switching stage providing an output voltage and an active EMI filter having an input and an output, the input of the active EMI filter connected to receive the output voltage and the output of the active EMI filter providing a filtered output voltage.

2. The circuit arrangement of claim 1, wherein the power transistor switching stage comprises an output stage comprising an inductor and a capacitor with the output voltage provided across the capacitor.

3. The circuit arrangement of claim 1, wherein the active EMI filter comprises an amplifier stage having two transistors each controlled by a current sensor, the current sensor sensing the presence of a common mode current to a load connected to the active EMI filter, said two transistors having a common connection coupled to an isolating capacitor coupled to a ground line, the isolating capacitor passing a current to cancel the common mode current in said ground line.

4. The circuit arrangement of claim 3, wherein the two transistors are complementary.

5. The circuit arrangement of claim 3, wherein the ground line connects the load and the power transistor switching stage.

6. The circuit arrangement of claim 1, wherein the output voltage of the power transistor switching stage is DC.

7. The circuit arrangement of claim 1, wherein the output voltage of the power transistor switching stage is AC.

8. The circuit arrangement of claim 1, wherein the power transistor switching stage is a switch mode power supply.

9. The circuit arrangement of claim 1, wherein the power transistor switching stage is a converter.
